(19) United States
(12) Patent Application Publication
(10) Pub. No.: US 2013/0117137 A1
(43) Pub. Date: May 9, 2013

(54) CONSUMER OPERATED KIOSK FOR SAMPLING BEAUTY PRODUCTS AND ASSOCIATED SYSTEMS AND METHODS

(71) Applicant: Coinstar, Inc., Bellevue, WA (US)

(72) Inventors: Franz Klein, Princeton, NJ (US); Alex Aziz Doumani, Portland, OR (US); Stacie Caine Bogdan, Chicago, IL (US)

(73) Assignee: Coinstar, Inc., Bellevue, WA (US)

(21) Appl. No.: 13/671,299

(22) Filed: Nov. 7, 2012

Related U.S. Application Data
(60) Provisional application No. 61/556,717, filed on Nov. 7, 2011.

(51) Int. Cl. G06Q 20/18; G06Q 30/02; G06Q 30/00; G06Q 20/20

(52) U.S. Cl. 705/16; 705/14.37; 705/27.1

(57) ABSTRACT

The present disclosure is directed to consumer operated kiosks for sampling products and associated systems and methods. In one embodiment, for example, a method of selling beauty products can include providing a consumer operated kiosk including an inventory of product samples. The product samples correspond to products available for purchase by consumers at a point of sale in a retail establishment. The method can further include displaying product information related to the product samples on the kiosk, and receiving a user selection corresponding to at least one of the product samples. The method can also include receiving payment for the selected product sample, and dispensing the selected product sample to the user from the kiosk.

### CROSS-REFERENCE TO RELATED APPLICATION(S)

This application claims the benefit of and priority to U.S. Provisional Patent Application No. 61/556,717, filed Nov. 7, 2011, which is incorporated herein by reference in its entirety.

### TECHNICAL FIELD

The present disclosure relates generally to systems, apparatuses and methods for sampling products and, more particularly, to consumer operated kiosks for sampling beauty products and/or other related products and services.

### BACKGROUND

Consumers often prefer to sample certain products before buying full size versions of the products. Cosmetics and other beauty products, for example, are typically tested for color, texture, smell and other characteristics before they are bought.

The current options for sampling beauty products, however, require the presence of a salesperson that has specific knowledge related to the beauty product so that he or she can convey product information and associated beauty tips to consumers. Other beauty products are sold without the ability to test the products, such as many cosmetics sold at drug stores. Accordingly, it would be advantageous to provide consumers with a relatively easy way to test samples of beauty products and other consumer goods before buying full size versions of the products.

### BRIEF DESCRIPTION OF THE DRAWINGS

FIGS. 1A and 1B are front and side views, respectively, of a consumer operated kiosk for sampling products configured in accordance with an embodiment of the disclosure.

FIGS. 1C-1E are front views of kiosk systems including the kiosk of FIGS. 1A and 1B configured in accordance with embodiments of the disclosure.

FIG. 1F is an isometric view of a product display configured in accordance with an embodiment of the disclosure.

FIGS. 2A-2F illustrate display pages for purchasing sample products using a consumer operated kiosk configured in accordance with an embodiment of the disclosure.

FIGS. 3A-3E illustrate display pages for purchasing sample products using a consumer operated kiosk configured in accordance with another embodiment of the disclosure.

FIGS. 4A-4E illustrate display pages for purchasing sample products using a consumer operated kiosk configured in accordance with a further embodiment of the disclosure.

FIG. 5 illustrates a suitable network environment for implementing various aspects of the consumer operated kiosks of the disclosure.

FIGS. 6-14 illustrate various aspects of consumer operated kiosks for sampling products configured in accordance with further embodiments of the disclosure.

FIG. 15 is an isometric view of a consumer operated kiosk for sampling products configured in accordance with yet another embodiment of the disclosure.

FIG. 16A is an isometric view of a robotic retrieval system for consumer operated kiosks configured in accordance with an embodiment of the disclosure.

FIGS. 16B-16D are enlarged isometric views of portions of the storage and delivery features of FIG. 16A.

### DETAILED DESCRIPTION

The present disclosure describes various embodiments of consumer operated kiosks for sampling products (e.g., beauty products) and associated systems and methods. Consumer operated kiosks can be configured to provide information and/or dispense products without the presence of a salesperson or vendor. A kiosk configured in accordance with several embodiments of the disclosure sells or otherwise distributes product samples, such as beauty product samples, so that consumers can test the products before purchasing commercially sold (e.g., full size) versions of the products. The kiosk can also be configured to provide consumers with coupons for a discount on full size versions of the product samples. In other embodiments, companies can rent the kiosk to distribute free samples of their products in exchange for consumer information (e.g., email addresses). Various embodiments of consumer operated kiosks are described herein with exemplary references to beauty products, such as cosmetics. However, product sampling kiosks in accordance with the disclosure can be used to sell or otherwise distribute other types of product samples.

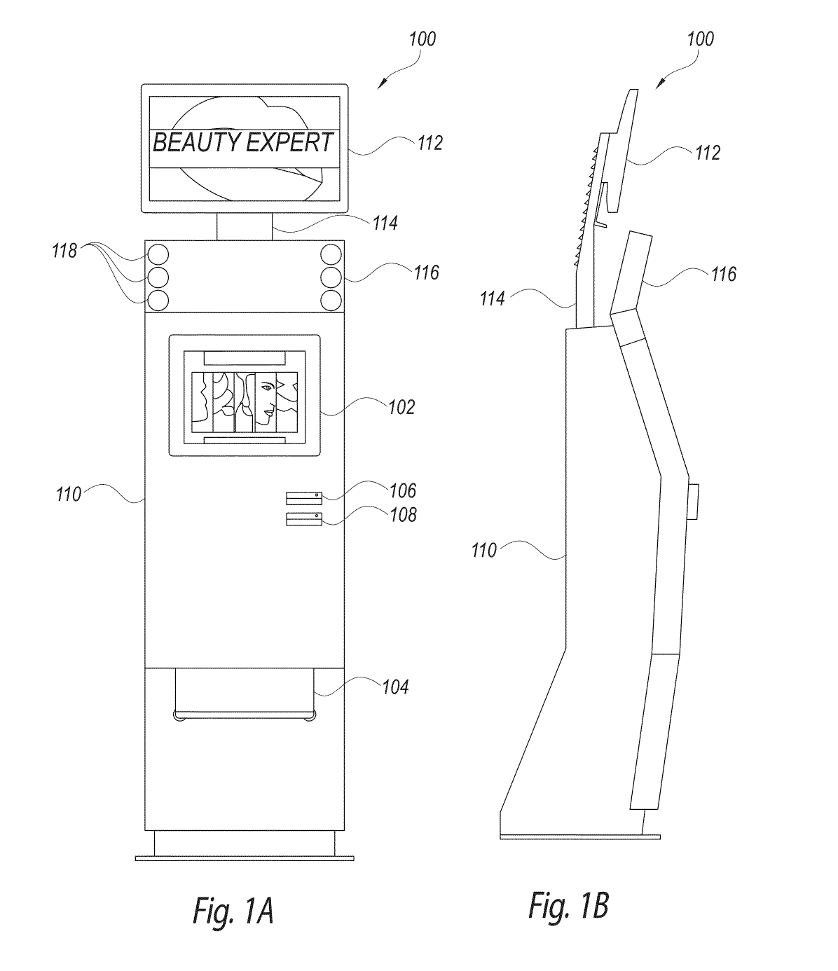

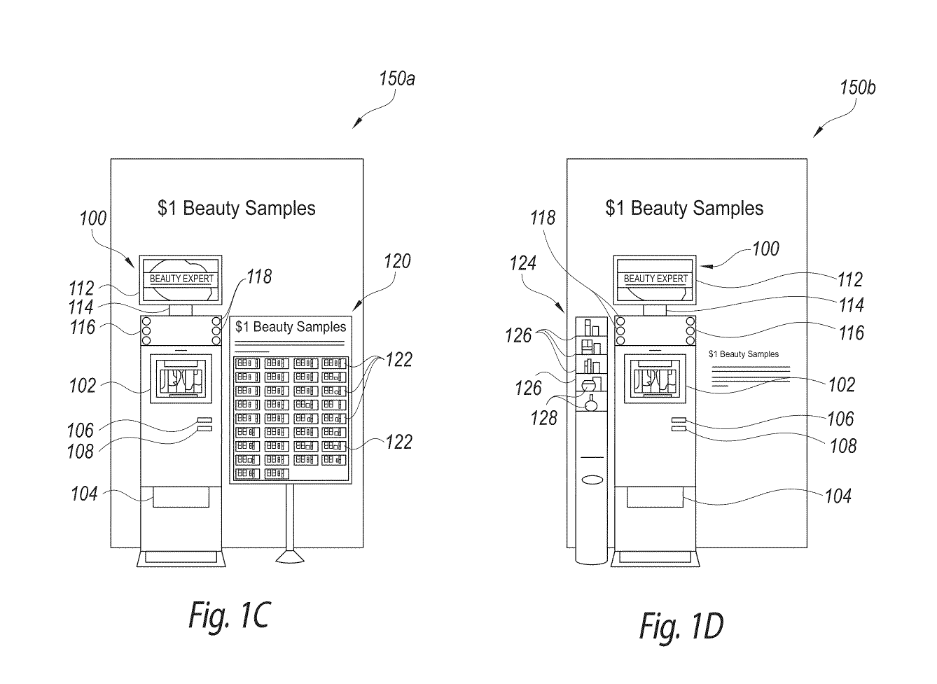

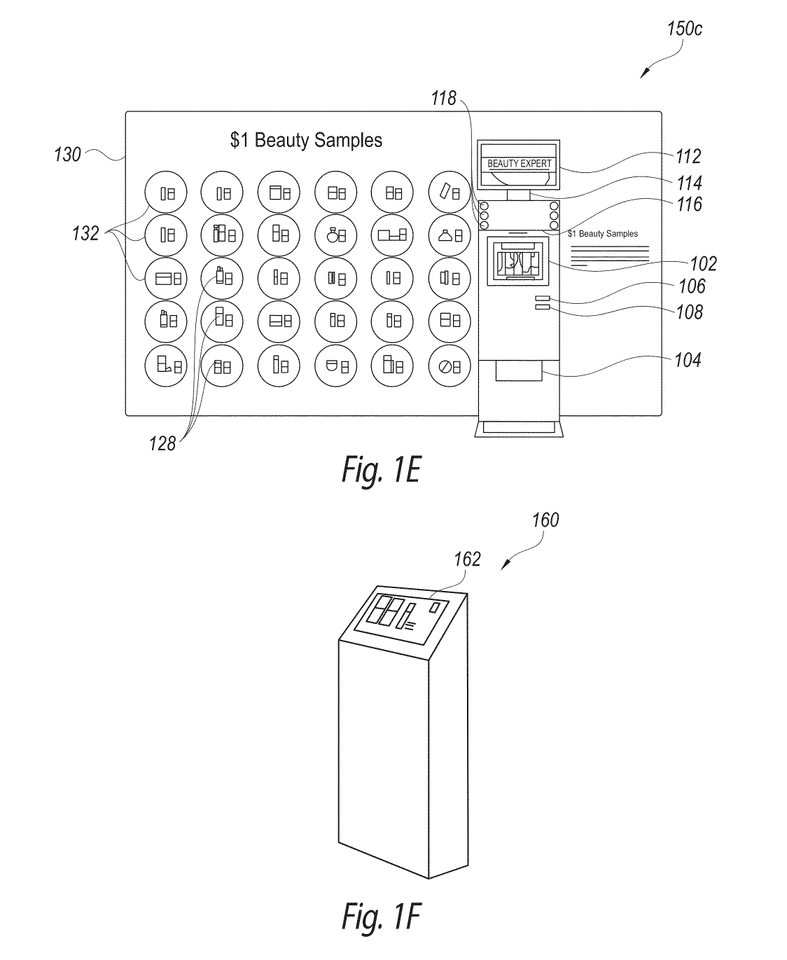

Certain details are set forth in the following description and in FIGS. 1A-16D to provide a thorough understanding of various embodiments of the disclosure. Other well-known structures and systems often associated with consumer operated kiosks, sampling products, and related commerce systems have not been shown or described in detail below to avoid unnecessarily obscuring the descriptions of the various embodiments of the disclosure. Additionally, a person of ordinary skill in the relevant art will understand that the disclosure may have additional embodiments that may be practiced without several of the details described below. In other instances, those of ordinary skill in the relevant art will appreciate that the methods and systems described can include additional details without departing from the spirit or scope of the disclosed embodiments.

Many of the details, dimensions, functions and other features shown and described in conjunction with the Figures are merely illustrative of particular embodiments of the disclosure. Accordingly, other embodiments can have other details, dimensions, functions and features without departing from the spirit or scope of the present disclosure. In addition, those of ordinary skill in the art will appreciate that further embodiments of the disclosure can be practiced without several of the details described below.

FIGS. 1A and 1B are front and side views, respectively, of a consumer operated kiosk 100 for sampling products configured in accordance with an embodiment of the disclosure. The kiosk 100 includes a housing 110, a user interface 102 that can communicate with consumers, and a product dispenser 104 (e.g., a vending slot or opening) that can dispense product samples to consumers. In the illustrated embodiment, the user interface 102 includes a display screen and/or a touch screen that can provide information to and receive information from consumers. In other embodiments, the user interface 102 can include other input devices that can provide and/or receive consumer information, such as a keyboard, an encrypted PIN pad, a voice command device, and/or other suitable user input devices known in the art. The kiosk 100 can also include a card reader 106 (e.g., a magnetic card swipe) and/or a currency acceptor 108 (e.g., a bill acceptor, change slot, etc.) that can receive various forms of payment from consumers.

In the illustrated embodiment, the kiosk 100 further includes a display 112 mounted on a support arm 114 over the housing 110 of the kiosk 100. The height and/or angle of the support arm 114 can be adjusted to position the display 112 in a desired location, such as the optimal viewing position for an average consumer. In one embodiment, the kiosk housing 110 can have a height of approximately 60 inches (152 cm) and the support arm 114 can extend the display 112 to a height of approximately 84 inches (213 cm). The display 112 can be a screen, a monitor, a digital read out, and/or other suitable devices configured to provide visual and/or audio information to consumers. The display 112, for example, can be configured to run a continuous loop of advertisements for various products sold or otherwise provided by the kiosk 100.

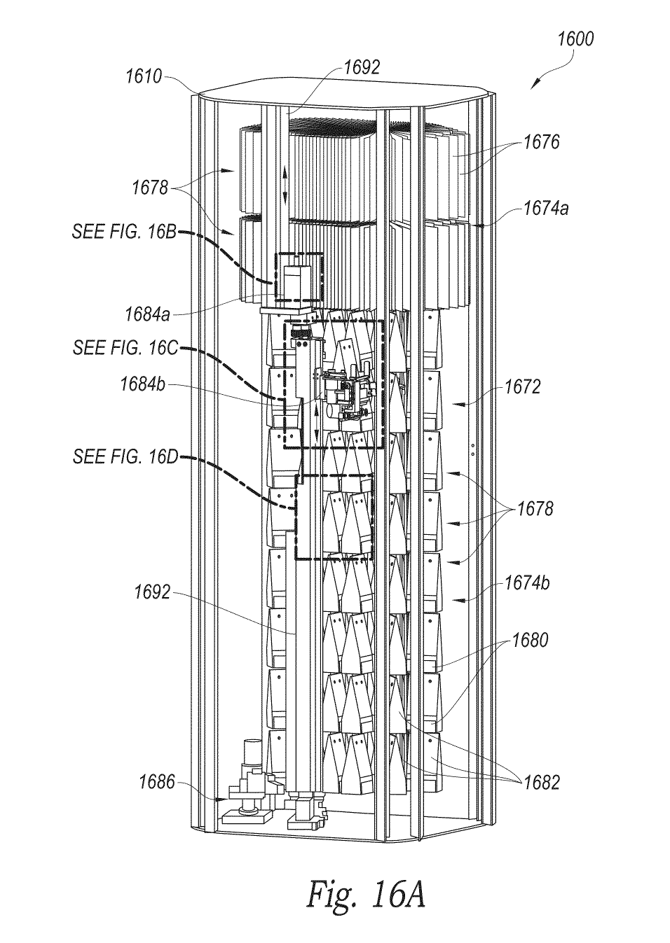

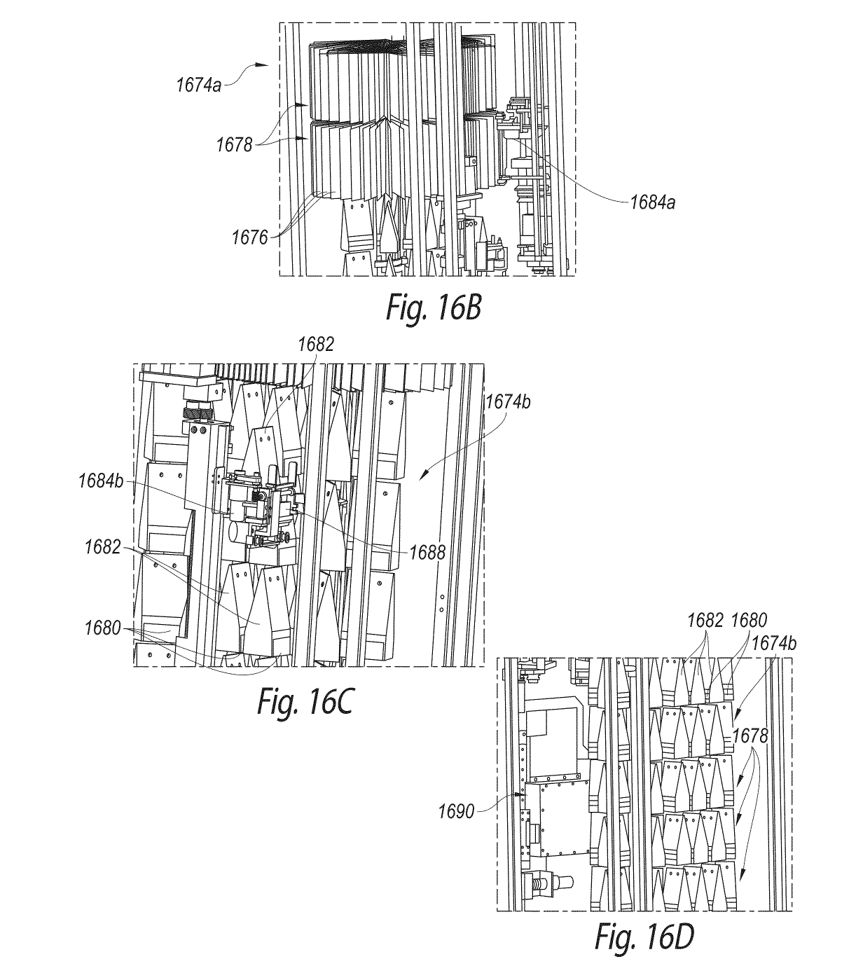

Various different types of product samples can be stored within the housing 110 of the kiosk 100. In one embodiment, the kiosk 100 can dispense the product samples using an interchangeable gravity-fed delivery cartridge similar to the cartridges in the kiosks made by Vigix, Inc. of Cambridge, Mass. Such gravity-fed delivery cartridges can include a limited number of moving parts, and therefore have a decreased likelihood of mechanical breakdown. In other embodiments, the kiosk 100 can include other suitable vending mechanisms known in the art to dispense product samples to consumers. As described in further detail below with respect to FIGS. 16A-16D, in further embodiments the kiosk 100 can include a robotic retrieval system that locates and retrieves product samples from predetermined positions on rotating carousels.

In the illustrated embodiment, the kiosk 100 is configured to store beauty product samples, such as cosmetics, skincare products, fragrances, nail polishes, hair products (e.g., styling products, care/cleaning products), etc. A consumer can select the beauty product(s) he or she wishes to sample via the user interface 102, pay for the product sample(s) via the card reader 106 and/or the currency acceptor 108, and retrieve the product sample(s) dispensed from the kiosk 100 via the product dispenser 104. The product samples can be individually packaged (e.g., individual sample lip sticks), pre-packaged as series of shades of the same product (e.g., individual lipstick samples having different hues, an eye shadow compact with different shades), and/or packaged with various related samples (e.g., a moisturizer and a toner). The display 112 and/or the user interface 102 can provide instructions to the consumer for using the kiosk 100, tips for applying the product samples, advertisement for various beauty products, and/or other signage.

The kiosk 100 allows retail establishments and manufacturers of the product samples to track the quantity and/or type of product samples consumers purchase from the kiosk 100 by monitoring the kiosk sales. This information can be used to gauge consumer interest in the various products sold at the kiosk 100. The kiosk 100 can also ensure that product samples are delivered to the end user, rather than taken home in bulk by salespersons or stored/discarded as may be true of manually distributed sample products.

As shown in the illustrated embodiment, the kiosk 100 can further include a mirror 116 illuminated by a plurality of lights 118 to allow consumers to immediately test the beauty product samples obtained from the kiosk 100. By doing so, consumers can decide in-store whether to purchase a full size version of the sample, thereby encouraging product sales. In one embodiment, the mirror 116 is configured to fold down to provide access to the interior of the kiosk 100 for restocking.

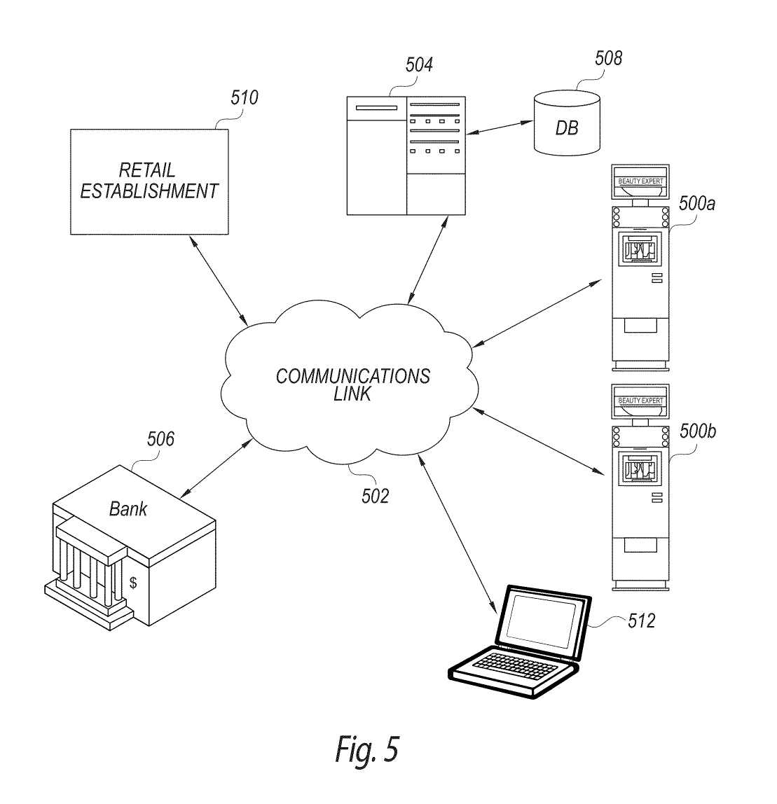

In various embodiments, the kiosk 100 can sell product samples to consumers for a fee (e.g., $1 per sample) and, optionally, at least a portion of that fee can be discounted from the price of the commercially sold (e.g., full size) product if the consumer decides to purchase the product. The kiosk 100 can dispense a coupon (e.g., printed on a receipt or as a separate coupon) via the product dispenser 104 or from a separate coupon/receipt dispenser (not shown), or the coupon can come packaged with the product sample (e.g., in an alligator-style package). In other embodiments, the kiosk 100 is operatively coupled to a communications link (e.g., the Internet, LAN, intranet, etc. explained in greater detail below with reference to FIG. 5) that allows the kiosk 100 to wirelessly communicate with and transfer the coupon directly to the point of sale (e.g., to a cash register in a drugstore or a department store) and associate the coupon with the consumer (e.g., using credit card information and/or other user identification information). When the coupon is provided by the manufacturer of the sample product, the direct communication between the point of sale and the kiosk 100 allows retail establishments (e.g., drugstores, department stores, grocery stores, etc.) to recoup the discounted value of the product. In other embodiments, the coupon may have certain restrictions to ensure that the retail establishment recoups the discounted value, such as only allowing the coupon to be used in the same store as the kiosk 100 or the same chain of stores.

The kiosk 100 may also be configured to promote or instruct the consumer to provide additional information via the user interface 102, such as an email address, mobile phone number, or other electronic address. The kiosk 100 can use this information to send the consumer a virtual coupon or discount code via email or an application on a smart phone. The kiosk 100 may also be configured to interact with smart phones in its near field to transfer the virtual coupon directly to the smart phone. The virtual coupon can then be provided at the point of sale by displaying it for a cashier on a smart phone or positioning it in the near field of a suitable terminal at the check-out point. The additional information provided by the consumer may also be used to send the consumer additional coupons (e.g., related to the purchased product sample), recommendations and tips related to the purchased product sample, and/or other information or offers that may be of interest to the consumer (e.g. magazine subscription offers).

In other embodiments, the kiosk 100 can be configured to read a loyalty card for a retail establishment (e.g., a grocery store loyalty card, department store card, etc.), a credit card and/or a debit card via the card reader 106 and/or other suitable card identifying device when the consumer purchases a product sample. The coupon can be added to the consumer's loyalty card account (e.g., stored in a database via a communications link described in detail below) and/or otherwise associated with card information (e.g., associated with the user's credit card number on a central computer), and later used at the retail establishment by providing the card or associated information (e.g., telephone number) at the point of sale. The card information can also be used track purchases made by the consumer at the kiosk 100 or kiosks linked thereto in a kiosk network.

In various embodiments, the kiosk 100 can receive consumer information to identify consumers and associate consumers with transactions at the kiosk 100 and/or kiosks communicatively linked to the kiosk 100 in the same network. The kiosk 100, for example, can be configured to receive a consumer's email address or user login information associated with a user account created at the kiosk 100 via the user interface 102 and/or remotely on a website (e.g., using a home computer, smart phone, etc), or read the consumer's a credit or debit card via the card reader 106. The kiosk 100 can also be configured to identify consumers using biometric data (e.g., using fingerprints and/or facial recognition software). The kiosk 100 and/or a remote central computer linked thereto can use the consumer information to track the consumer's transactions at the kiosk 100 and kiosks within the same network. Retail establishments and/or manufacturers of the product samples sold at the kiosk 100 can use this information to send targeted advertisements, coupons, samples, and/or other offers to the consumer.

As mentioned above, consumers can create a user account at the kiosk 100 or using a remote device (e.g., on a website accessed via a home computer or smart phone). The user account can include additional information about the consumer, such as coloring characteristics (e.g., skin tone, hair color, eye color, etc.) and/or beauty concerns (e.g., dry skin, sensitive skin, oily hair, etc). The kiosk 100 can input this information into algorithms to recommend certain product samples available at the kiosk and/or related products.

In other embodiments, the kiosk 100 can be configured to distribute at least some free samples to consumers. A product manufacturer or retail establishment can rent the kiosk 100 and use it to gauge consumer interest in products by tracking the sample products consumers select most frequently. This can provide a more accurate and cost-effective method of distributing and tracking samples than manual distribution (e.g., as is done by a salesperson in many department stores). The kiosk 100 can also provide more detailed product information to consumers via the user interface 102 and/or the display 112 than a salesperson who may not have the time or the expertise to explain the product details. In some embodiments, the kiosk 100 is configured to require consumers to enter identification information (e.g., an email address) in exchange for the free sample. This information can then be used to send targeted advertisements, offers, samples, etc. to consumers.

FIGS. 1C-1E are front views of kiosk systems 150 (identified individually as kiosk systems 150a-c, respectively) configured in accordance with embodiments of the disclosure. The kiosk systems 150 include the kiosk 100 of FIGS. 1A and 1B and product displays that advertise the product samples sold or otherwise distributed by the kiosk 100. In the embodiment illustrated in FIG. 1C, for example, the kiosk system 150a includes a lighted display panel 120 (known as a “lightbox”) with a plurality of display boxes 122 including graphics corresponding to the product samples distributed by the kiosk 100. The graphics within the display boxes 122 can be changed manually by accessing the interior of the display panel 120 and replacing the graphics in one or more of the display boxes 122. In some embodiments, the display boxes 122 are illuminated by fluorescent light bulbs, LED lighting strips, and/or other suitable lighting devices positioned behind the face of the display panel 120. In other embodiments, the display boxes 122 can be individually illuminated, and the display panel 120 can be operatively coupled to the kiosk 100 such that individual display boxes 122 can be darkened or otherwise changed when the associated product sample is no longer available at the kiosk 100.

As shown in FIG. 1D, in other embodiments, the kiosk system 150b can include a display column 124 having a plurality of shelves 126. The shelves 126 can display full size products 128 of one or more of the product samples in the kiosk 100 and/or the product samples themselves. In various embodiments, the shelves 126 can be illuminated to provide an aesthetically pleasing display of the full size products 128.

As shown in FIG. 1E, the kiosk system 150c can include a large panel 130 that displays the full size products 128 in individual compartments 132. The compartments 132 can be equally sized and have a generally circular shape as shown in FIG. 1E, or the compartments 132 can have other suitable shapes and sizes. The compartments 132, for example, may be a mixture of shapes and sizes corresponding to the individual shapes and sizes of the products 128 displayed therein. The compartments 132 can be individually illuminated to increase the aesthetic appeal of each product 128. In other embodiments, two or more compartments 132 (e.g., the entire panel 130) can be backlit by suitable lighting.

FIG. 1F is an isometric view of a product display 160 configured in accordance with an embodiment of the disclosure. The product display 160 includes a user interface 162 (e.g., a touch screen or other display) that communicates with consumers and provides information related to products and product samples sold by the kiosk 100 (FIG. 1A). As such, the product display 160 can be included in the kiosk systems 150a-c described above as an alternative to or in addition to the product displays described above (e.g., the lighted display panel 120, the display column 124, and the large display panel 130).

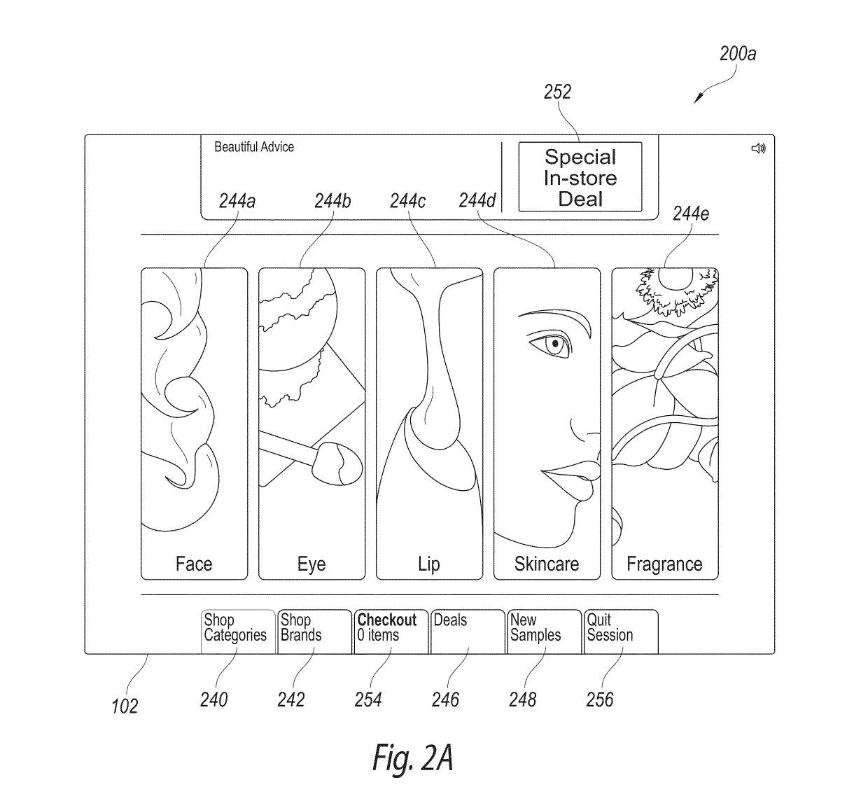

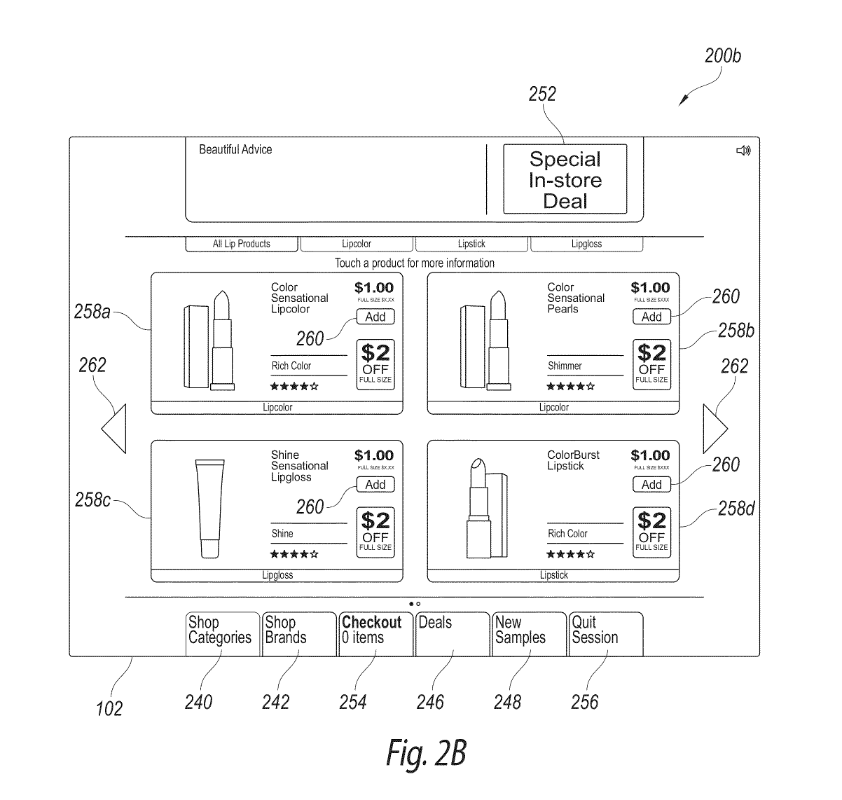

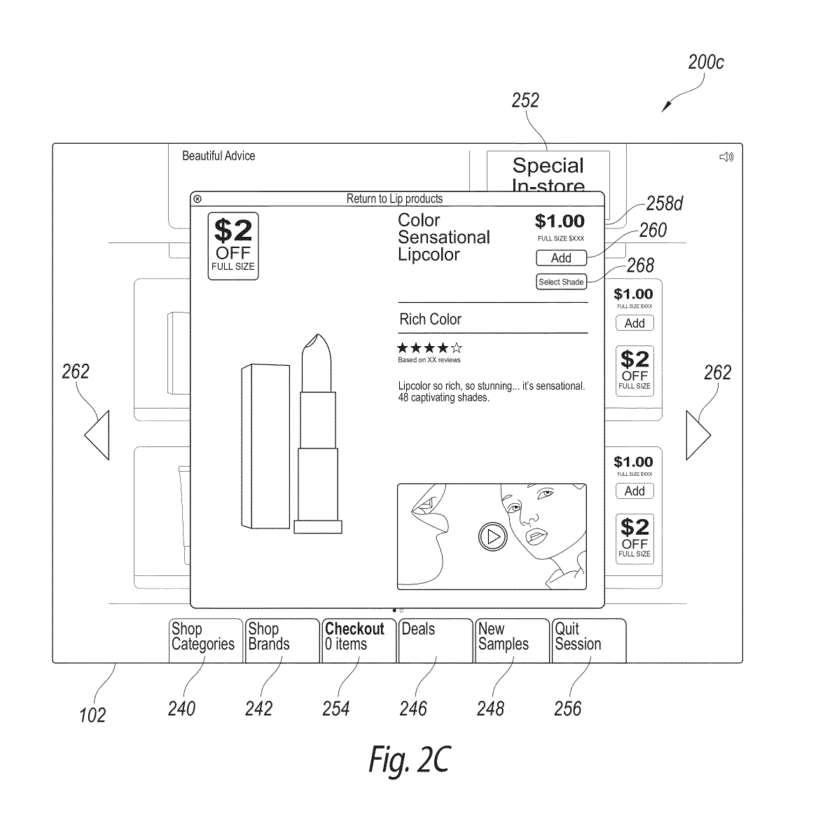

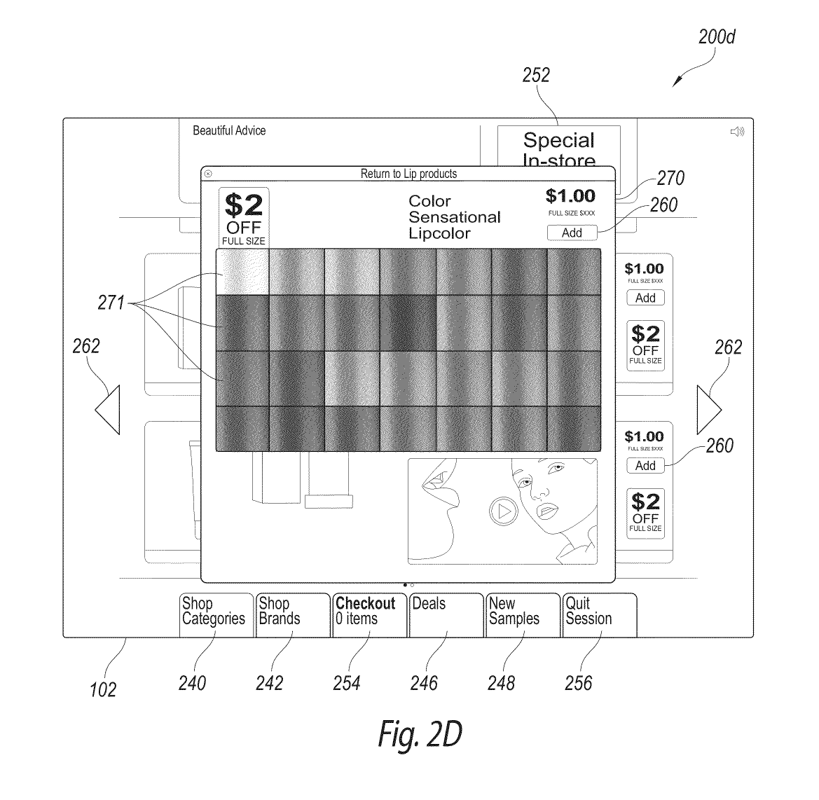

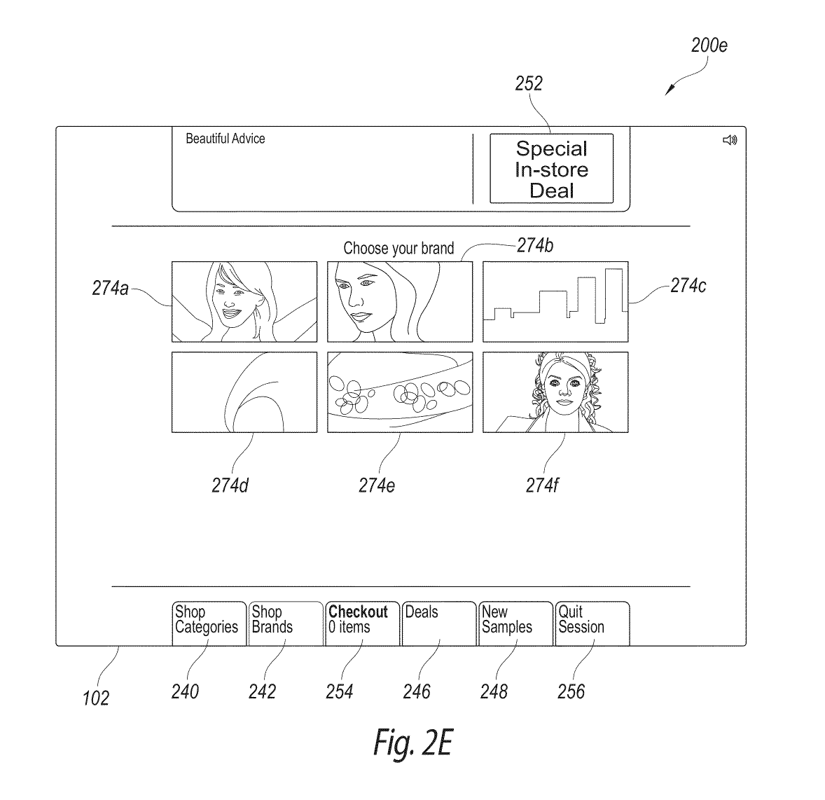

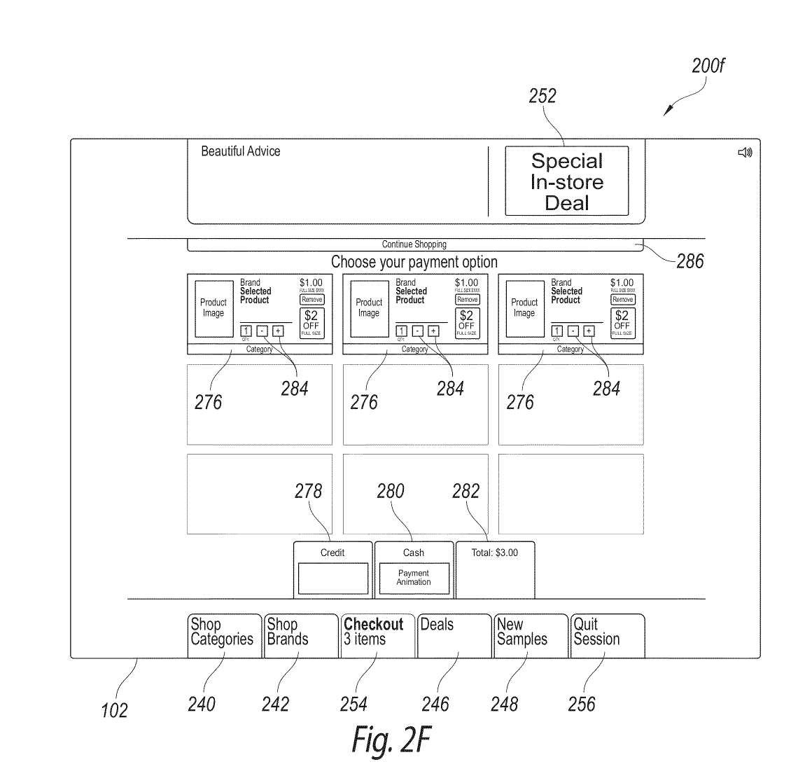

The kiosk 100 described above can operationally interface with consumers via visual and/or audible signals, textual instructions, animations, dialogue boxes, selector buttons, icons, prompts, and/or other features provided to consumers via the user interface 102. FIGS. 2A-2F, for example, illustrate display pages 200a-f on the user interface 102 that can be used to purchase product samples available at the kiosk 100. In other embodiments, the display pages 200a-f can be displayed on other portions of the kiosk 100 (e.g., on the display 112) or on displays coupled to the kiosk 100.

Referring first to FIG. 2A, the display page 200a can include various search icons or buttons, such as a “Shop Categories” button 240 and a “Shop Brands” button 242, that allow the consumer to select how to navigate to the product samples he or she is interested in buying. In the illustrated embodiment, the display page 200a corresponds to a user selection of the “Shop Categories” button 240, and includes plurality of buttons 244a-e that divide the product samples into categories (e.g., face, eye, lip, skincare, and fragrance). The display page 200a can also include a “Deals” button 246 that navigates the user interface 102 to one or more pages of special deals or promotions on the product samples (e.g., buy one, get one free), a “New Samples” button 248 that navigates the user interface 102 to one or more pages of product samples that have been newly added to the kiosk 100 within a predetermined period of time (e.g., within the last seven days), and an “In-store” deal button 252 that navigates the user interface 102 to a page that provides deals available at the retail establishment in which the kiosk 100 is located.

As further shown in FIG. 2A, the display page 200a can also include a “Checkout” button 254 that navigates the user interface 102 to a page where the consumer can purchase the selected product samples. The “Checkout” button 254 can include a running total of the number of items (e.g., product samples) that the consumer has selected for purchase. If the consumer does not wish to purchase any or further product samples, the consumer can select a “Quit Session” button 256 that exits the session and, if the consumer has logged into his or her user account (e.g., using an email and password, a credit card, a loyalty card, etc.), automatically log the consumer out of the session.

When the consumer selects the “Lip” category button 244c, the user interface 102 can navigate to the display page 200b shown in FIG. 2B that displays various lip-related product sample buttons 258a-d for sale at the kiosk 100. The product sample buttons 258a-d include information about each of the product samples, such as a graphic of the product, the brand of the product (e.g., “Revlon®”), the name of the product (e.g., “ColorBurst Lipstick”), consumer ratings (e.g., as indicated by the number of highlighted stars), the price of the product sample, the price of the full size product, the discount or coupon value associated with buying the product sample, the sub-category of the product (e.g., lip gloss versus lipstick), and/or various other information related to the product sample and/or purchasing the product sample. The product sample buttons 258a-d can also include an “Add” button 260 that places the product sample in a virtual shopping cart until it is purchased by the consumer during checkout from the kiosk 100. The display page 200b can also include arrow buttons 262 that allow the consumer to toggle between pages of product sample buttons 258 and/or subcategory buttons 244 (e.g., lip color, lipstick, and lip gloss) that allow the consumer to narrow the categories into subgroups.

When the consumer selects one of the product sample buttons 258, the user interface 102 can display a panel or pop-up window 266 as shown in FIG. 2C that provides additional information about the product sample. In the illustrated embodiment, for example, the pop-up window 266 includes a video that can describe the product and/or provides tips and techniques on how to use the product. If the product sample comes in more than one color, the pop-up window 266 can include a “Select Shade” button 268 that displays a second pop-up window 270 illustrated in FIG. 2D. The second pop-up window 270 can include a plurality of buttons 271 corresponding to the different shades of the product. The consumer can select one of the shade buttons 271 and add the product sample in the selected shade to the virtual shopping cart using the “Add” button 260. If the consumer does not wish to select a sample shade, the consumer can navigate away from the pop-up window 270 by selecting a close button 272 at the upper corner of the pop-up window 270 and/or touching elsewhere on the user interface 102 outside the pop-up window 270.

FIG. 2E illustrates the display page 200e that corresponds to the selection of the “Shop Brands” button 242, and includes a plurality of brand buttons 274a-f corresponding to the brands sold at the kiosk 100. The consumer can use the brand buttons 274 to navigate the user interface 102 to a page that displays product samples made by the selected brand similar to the product sample buttons 258 shown in FIG. 2B. In some embodiments, the brand-specific product samples can further be narrowed by selecting buttons associated with categories (e.g., lip, face, fragrance, skincare, etc.) and/or subcategories (e.g., foundation, blush, powder, etc.).

When the consumer is ready to purchase the selected samples, the consumer can select the “Checkout” button 254, and the user interface 102 can navigate to the display page 200f shown in FIG. 2F. The selected product samples can be indicated in individual frames 276 that include various features of the product samples. In the illustrated embodiment, for example, the individual frames 276 include generally similar information as the features in the product sample buttons 258 (FIG. 2B), such as an image of the product, the price of the product sample and the full size product, the coupon value, etc. The selected product frames 276 can also include quantity selection buttons 284 that allow the consumer to select the number of samples of each product he or she wishes to buy. In some embodiments, the kiosk 100 may be configured to have an upper limit to the quantity of product samples (e.g., three) per consumer or per transaction.

Once the consumer is ready to check out, he or she can view the total cost of the selected samples in the total box 282 and select a method of payment using a “Credit” button 278 and/or a “Cash” button 280. Depending upon the method of payment chosen, the kiosk 100 (FIG. 1A) can receive credit or debit card payments via the card reader 106 (FIG. 1A) or cash via the currency acceptor 108 (FIG. 1A). The kiosk 100 can then dispense the purchased product samples via the dispenser 104 (FIG. 1A). If the consumer wishes to continue browsing the product samples, the consumer can select a “Continue Shopping” button 286 to navigate the user interface 102 to a page (e.g., the display page 200b of FIG. 2B corresponding to the “Shop Categories” button 240).

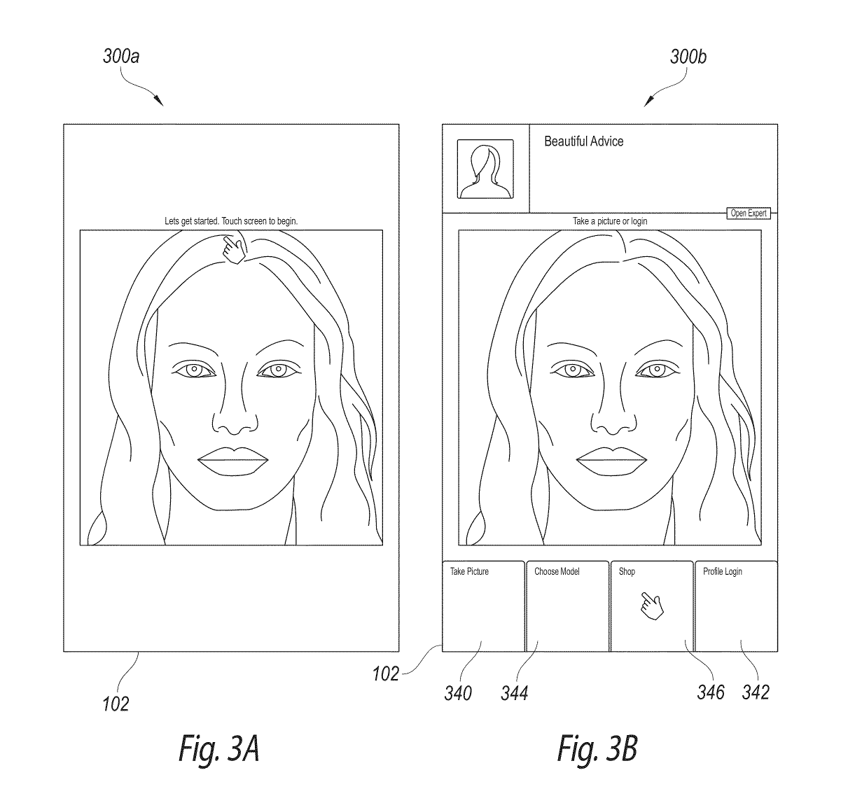

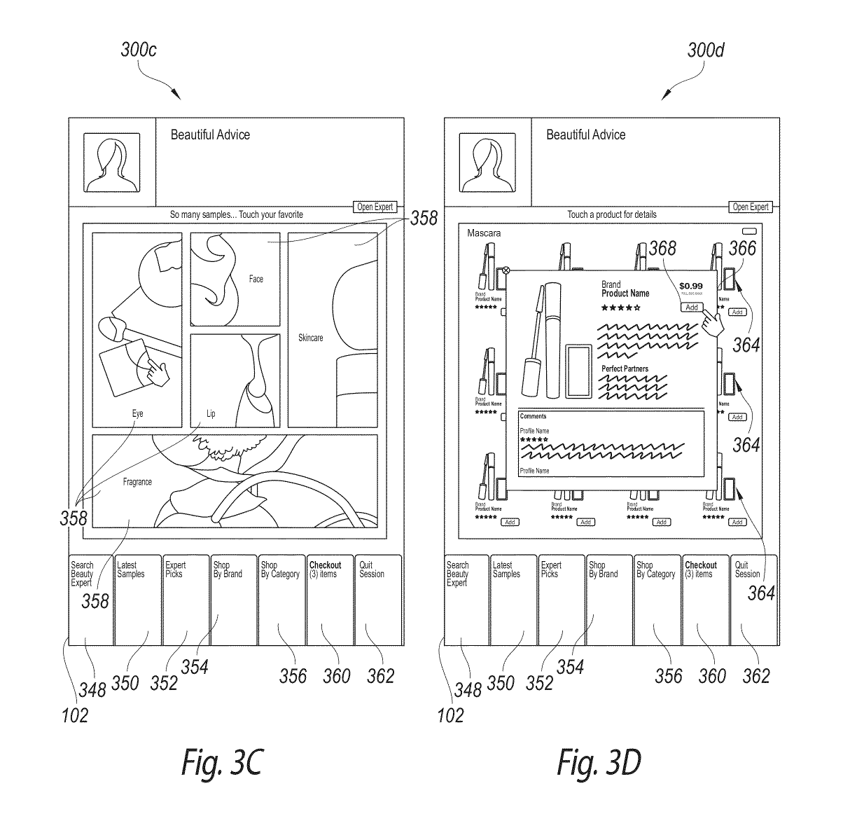

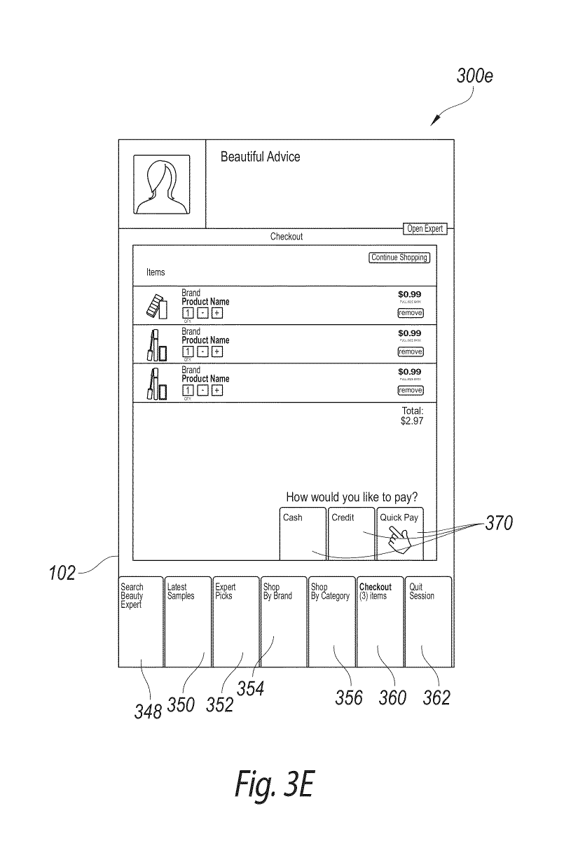

FIGS. 3A-3E illustrate display pages 300a-e on the user interface 102 for purchasing product samples in accordance with another embodiment of the disclosure. As shown in FIG. 3A, a consumer can touch the display page 300a to activate the kiosk 100 (FIG. 1A), and the user interface 102 can then navigate to the display page 300b shown in FIG. 3B to provide the consumer with a plurality of options. The display page 300b can include, for example, a “Take Picture” button 340 that allows the consumer to take a profile picture of himself or herself using a camera (not shown) in the kiosk 100. The display page 300b can also provide information regarding how best to take the profile picture (e.g., where to stand in relation to the kiosk 100). If the consumer has previously created a user account linked to the kiosk 100, he or she can select a “Profile Login” button 342 that navigates the user interface 102 to a login page where the consumer can enter login information (e.g., a login name and password) and sign into his or her account. The consumer can then use a profile picture associated with the user account or opt to take a new profile picture. The consumer can alternatively choose to select a profile picture of a model having similar features to the consumer using a “Choose Model” button 344. The profile picture can later be used to recommend products for the consumer. If the consumer does not wish to select a profile picture, the consumer can also bypass this step by selecting a “Shop” button 346.

The “Shop” button 346 can navigate the user interface 102 to the display page 300c illustrated in FIG. 3C, which provides the consumer with various ways to view the available product samples. The consumer can select, for example, a “Search Beauty Expert” button 348 that allows the consumer to manually search the available samples by entering search terms (e.g., via a keypad or a virtual keypad on the user interface 102), a “Latest Samples” button 350 to view recent additions to the kiosk 100, and/or a “Shop by Brand” button 354 or a “Shop by Category” button 356 to product samples specific to a selected brand or category.

As shown in FIG. 3C, the “Shop by Category” button 356 can display various category buttons 358 that pertain to the types of beauty product samples available at the kiosk 100. As explained in greater detail below, an “Expert Picks” button 352 can be selected to display product samples and shades that are chosen based on features of the consumer's profile picture, such as skin tone, hair color, eye color, etc.

The consumer can navigate to the display page 300d shown in FIG. 3D by selecting the eyes category button 358 (FIG. 3C) and a subcategory thereof pertaining to mascara. The background of the display page 300d illustrates various mascara product samples 364 available at the kiosk 100, and the foreground of the display page 300d illustrates a pop-up window 366 that provides various features related to a selected mascara (e.g., price of the sample mascara, user reviews, application tips, etc.). If the consumer decides to purchase the sample mascara, he or she can select the “Add” button 368 to place the mascara sample in a virtual shopping cart and a “Checkout” button 360 can be updated to show an additional item in the virtual shopping cart.

The consumer can select a “Checkout” button 360 to view, edit, and purchase items in his or her virtual shopping cart, and navigate the user interface 102 to the display page 300e shown in FIG. 3E. The consumer can select his or her method of payment using payment option buttons 370, such as cash, credit, or quick pay (e.g., using a previously stored credit card associated with a user account), and follow steps to pay for the product samples. Alternatively, the consumer can select a “Quit Session” button 362 to terminate the session without purchasing any product samples.

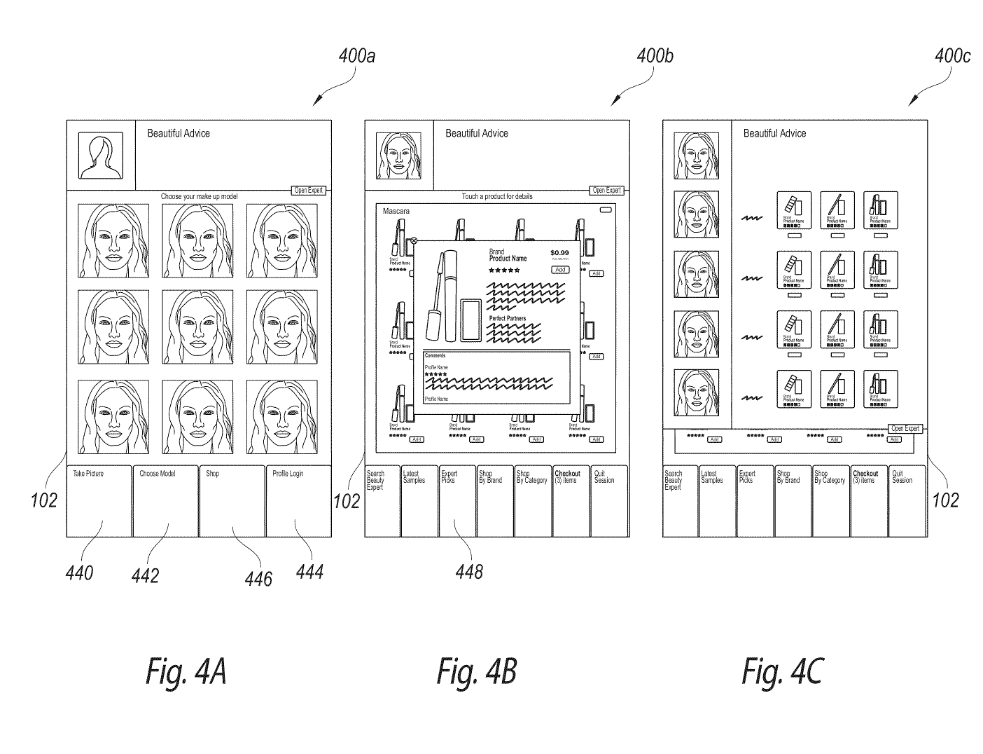

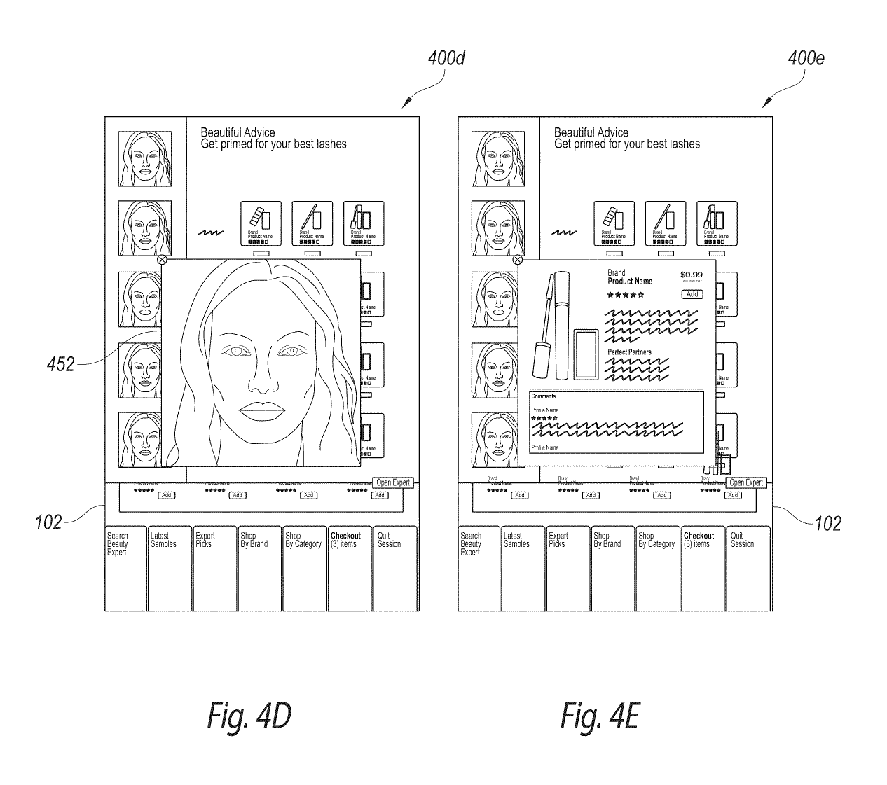

FIGS. 4A-4E illustrate display pages 400a-e that can be shown on the user interface 102 for purchasing product samples in accordance with yet another embodiment of the disclosure. The display page 400a illustrated in FIG. 4A, for example, allows a consumer to select a profile picture that the kiosk 100 (FIG. 1A) can use to make recommendations related to the product samples for sale at the kiosk 100. Similar to the display page 300b shown in FIG. 3B, the consumer can opt to take a picture of himself or herself using a “Take Picture” button 440 or select a picture of a model that has similar features (e.g., hair color, eye color, etc.) as the consumer using a “Select Model” button 442. The display page 400a can also include a “Profile Login” button 442 that allows the consumer to access his or her account such that the consumer can select a profile picture previously associate with the user account. Alternatively, the consumer can select a “Shop” button 446 to navigate away from the profile picture display page 400a and begin shopping for product samples. As shown in FIG. 4B, the user interface 102 can navigate to the display page 400b showing a variety of product samples for sale at the kiosk 100, and can prompt the consumer to input selections and/or additional information.

When the consumer selects an “Expert Picks” button 448, the user interface 102 can navigate to a the display page 400c shown in FIG. 4C that provides the consumer with recommendations based on the consumer's profile information (e.g., the profile picture). In the illustrated embodiment, the recommendations include “suggested looks” (e.g., natural makeup, daytime makeup, glam makeup, etc.) that can be created using one or more of the product samples for sale at the kiosk 100. The consumer can select one of the suggested looks, and the user interface 102 can open a pop-up window 452 that automatically simulates the suggested look on the consumer's profile picture as shown in FIG. 4D. If the consumer likes the suggested look, he or she can select the corresponding product sample(s) as shown in FIG. 4E to add to the consumer's virtual shopping cart.

FIG. 5 illustrates a suitable network environment for implementing various aspects of the kiosk system described above. One or more consumer operated kiosks 500 (identified individually as a first kiosk 500a and a second kiosk 500b) can be operatively connected to a server 504 via the Internet, a dedicated network, and/or other communications link 502. In some embodiments, the kiosks 500 are first networked to one or more host or central computers (not shown), which are in turn operatively connected to the communications link 502. Many features and aspects of the kiosks 500 are at least generally similar in structure and function to the kiosk 100 described in detail above. The server 504 performs much or all of the functions for receiving, routing, and storing of application programs, electronic messages, and other information associated with features of the kiosk network. The server 504 can include a server engine, a content management component, and a database management component. The server engine performs basic processing and operating system level tasks. The content management component handles many of the functions (e.g., managing the kiosk inventory and product information displayed by the kiosks 500) in the embodiments described herein. In other embodiments, these functions can be performed by the kiosks 500 themselves.

The database management component of the server 504 includes storage and retrieval tasks with respect to a database 508 coupled to the server 504, queries to the database 508, and storage of data. The database 508 can store at least some of the content exchanged between the kiosks 500, user profile information (e.g., profile pictures, consumer preferences, past purchases, etc.), and information related to the product samples. As will be apparent to those skilled in the art, the server 504 can include a single server or a plurality of servers, and the database 508 can include a single database or a plurality of databases. Additionally, the server 504, including the database 508, may employ security measures to inhibit malicious attacks on the system and to preserve the integrity of the messages and data stored therein (e.g., firewall systems, secure socket layers (SSL) password protection schemes, encryption, and the like).

In the illustrated embodiment, the communications link 502 is also connected to one or more financial institutions 506 (e.g., banks) and retail establishments 510 (e.g., drug stores, department stores, grocery stores, etc.). The kiosks 500 can communicate with the financial institutions 506 via the communications link 502 to perform credit and/or debit card transactions, provide payment options, and/or identify consumers. The kiosks 500 can communicate with the retail establishment 510 via the communications link 502 to wirelessly route product coupons to the point of sale (e.g., the cash register), access loyalty card information, etc. The communications link 502 can also connect the kiosks 500 to remote personal devices 512 (e.g., home computers, tablets, smart phones, etc.) where consumers can browse the product samples for sale at the kiosks 500, view product information, receive beauty advice, and edit their user profiles.

A network environment, such as the network environment illustrated in FIG. 5, can connect multiple kiosks 500 positioned in a plurality of publicly accessible areas, such as grocery stores, department stores, and drug stores. The maintenance and inventory of the networked kiosks 500 can then be managed from the backend by the server 504 and the database 508. The server 504, for example, can run routine maintenance checks on the kiosks 500 to identify mechanical problems and/or glitches in the user interface and display pages. The server 504 and the database 508 can also monitor the kiosk inventory to determine when each kiosk 500 needs to be restocked and with what (e.g., rather than having a maintenance person perform regular checkups). Additionally, the network environment allows product sample information (e.g., product details) to be added to the database 508 and uploaded to one or more of the kiosks 500 from the backend. In various embodiments, the product sample information can be added to the kiosks 500 only when the product samples are available for purchase at the kiosks 500. Other information, such as operating systems updates, can also be uploaded to the kiosks 500 from the backend via the communications link 502. The network environment also allows the user profile information to be stored in the database 508 and shared among the kiosks 500 in the network, and track consumer purchases at the networked kiosks 500.

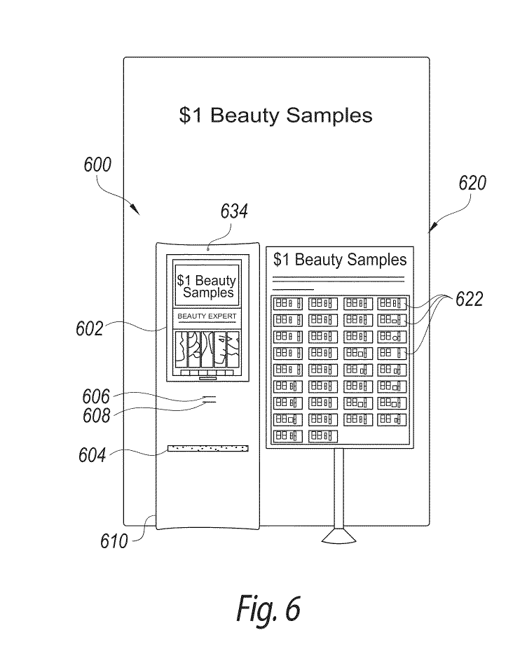

FIG. 6 is a front view of a consumer operated kiosk system 650 configured in accordance with another embodiment of the disclosure. The kiosk system 650 includes a kiosk 600 having many features that are at least generally similar in structure and function to the features of the kiosk 100 described above. The kiosk 600, for example, includes a user interface 602 that directs the sale of product samples stored within a kiosk housing 610, a product dispenser 604 that dispenses the purchased product samples, and a card reader 606 and a currency acceptor 608 that can be used to pay for the product samples. The user interface 602 illustrated in FIG. 6, however, is larger than the user interface 102 shown in FIG. 1A, and can accordingly display more information to consumers on a single page. The kiosk system 650 also includes a lighted display panel 620 that displays the various product samples for sale at the kiosk 600 in individual display boxes 622. The kiosk 600 further includes a camera 634 that can be used to take profile pictures of consumers. In various embodiments, the camera 634 can also take videos of consumers and display them in real-time on the user interface 602 such that it serves as a mirror for consumers to test the product samples.

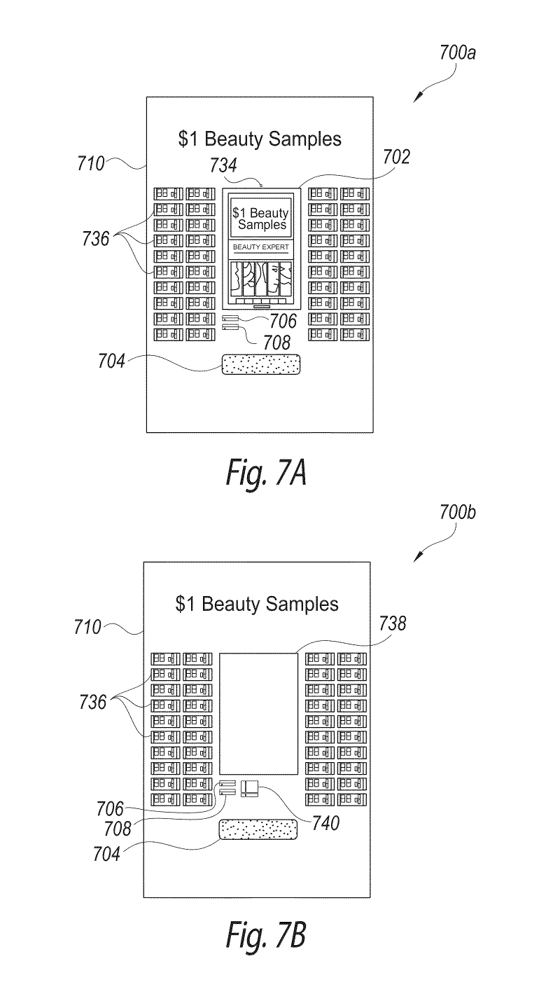

FIG. 7A is a front view of a consumer operated kiosk 700a configured in accordance with yet another embodiment of the disclosure. The kiosk 700a can include many features that are at least generally similar in structure and function to the features of the kiosks described above. In the illustrated embodiment, however, the kiosk 700a includes a plurality of display boxes 736 (e.g., backlit display compartments) integrated into a housing 710 rather than on a separate display (e.g., a lightbox). The display boxes 736 can display product samples and/or related information on the kiosk 700a. In various embodiments, the kiosk 700a can extend from an end of a shopping aisle (e.g., a grocery store aisle or drug store aisle) and serve as an endcap display.

FIG. 7B is a front view of a consumer operated kiosk 700b configured in accordance with a further embodiment of the disclosure. The kiosk 700b includes many features that are at least generally similar in structure and function to those of the kiosk 700a shown in FIG. 7A. The kiosk 700b, however, replaces the user interface with a vanity mirror 738 that allows consumers to test the product samples. Since the kiosk 700b does not include a user interface, the display boxes 736 can be numbered with coordinates, and consumers can enter the coordinates on a keypad 740 to select product samples for purchases. In other embodiments, the kiosk 700b can include a user interface (e.g., a touch screen) that can display a mirror 738 in response to a user command.

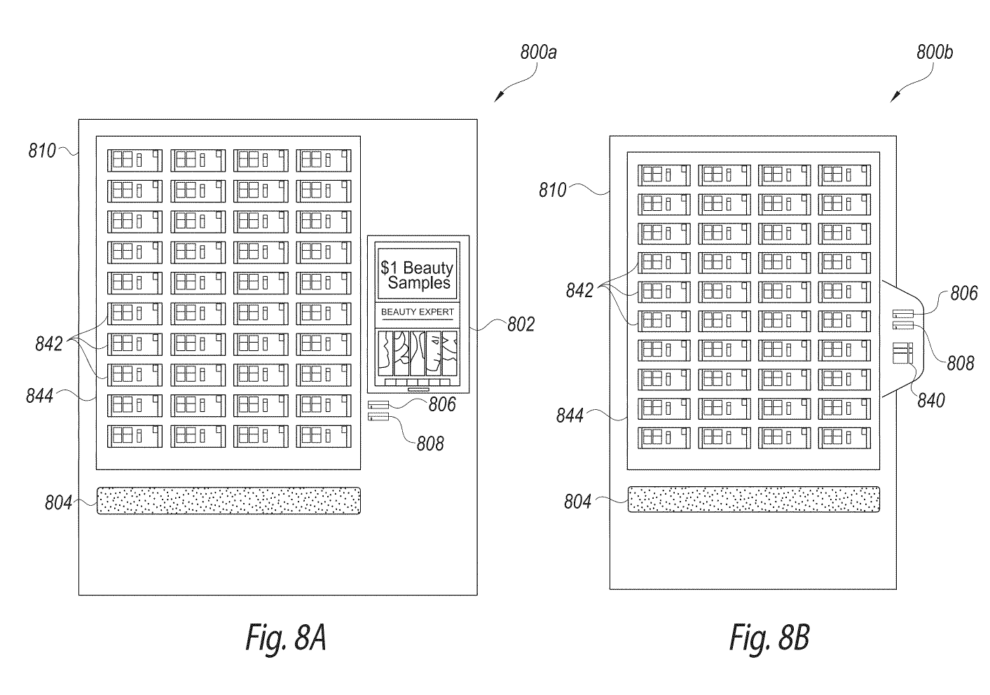

FIGS. 8A and 8B are front views of consumer operated kiosks 800a and 800b, respectively, configured in accordance with still further embodiments of the disclosure. The kiosks 800a-b can include many features that are at least generally similar in structure and function to the features of the kiosks described above. The kiosks 800a-b, however, include rows of product samples 842 that are displayed behind a glass panel 844 (e.g., similar to snack-style vending machines) such that consumers can see the product samples they are purchasing. In other embodiments, the product samples 842 can be represented by images and/or descriptions of the product. As shown in FIG. 8A, the kiosk 800a can include a user interface 802 that directs the purchase of the product samples 842 and provides information related to the product samples 842 (e.g., as described above with reference to FIGS. 2A-4E). In other embodiments, such as the kiosk 800b illustrated in FIG. 8B, the product samples 842 can be selected via a keypad 840 that allows consumers to enter coordinates corresponding to the desired product samples 842.

FIG. 9 is a front view of a consumer operated kiosk 900 configured in accordance with an additional embodiment of the disclosure. The kiosk 900 can include many features that are at least generally similar in structure and function to the features of the kiosks described above. In the illustrated embodiment, however, the kiosk 900 includes an enlarged user interface 902 that represents all the product samples for sale at the kiosk 900 as digital images 946 viewable on a single page. The consumer can select the digital images 946 to expand the product information and purchase the product samples. In various embodiments, the kiosk 900 can be mounted on a wall or other suitable structure to reduce the amount of floor space occupied by the kiosk 900.

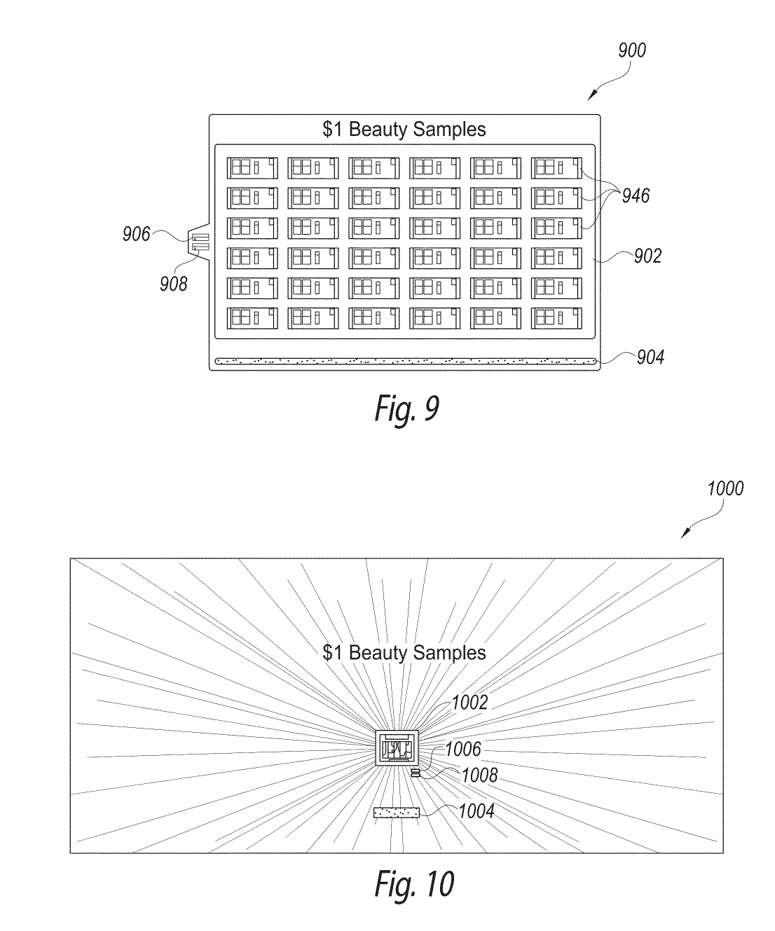

FIG. 10 is a front view of a consumer operated kiosk 1000 configured in accordance with another embodiment of the disclosure. The kiosk 1000 can include many features that are at least generally similar in structure and function to the features of the kiosks described above. The components of the kiosk 1000 (e.g., a user interface 1002, a product dispenser 10004), however, are installed or integrated directly into an existing or constructed wall, and therefore reduces the footprint of the kiosk 1000 on the retail floor. The surrounding wall may be used to display graphics that direct attention to the user interface 1002, advertise the kiosk 1000, and/or advertise products sold within the kiosk 1000.

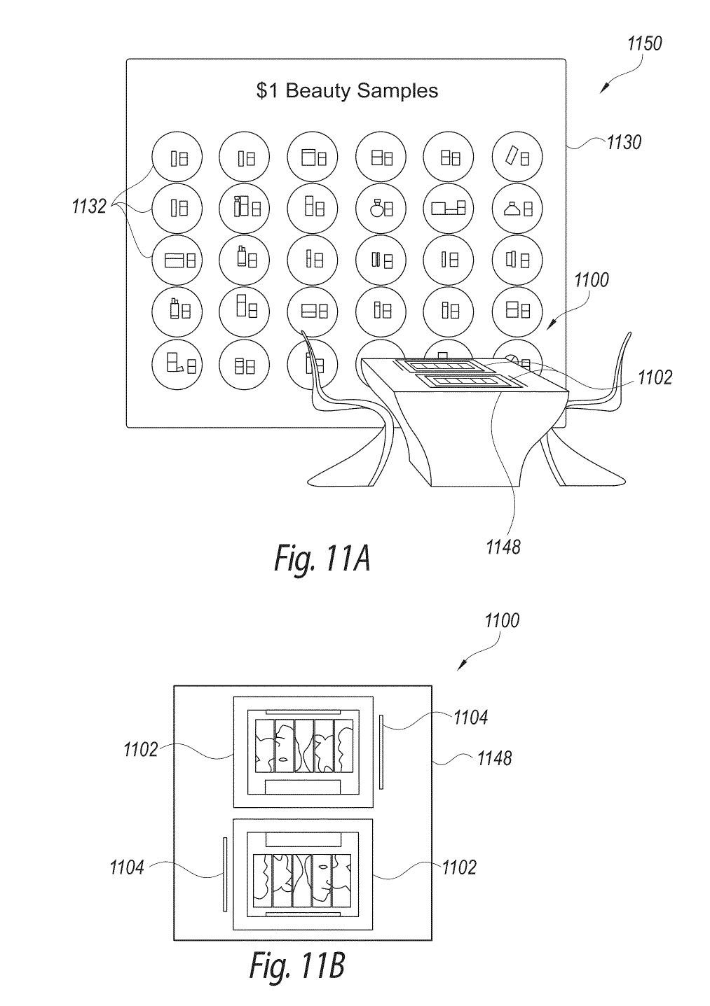

FIG. 11A is an isometric view of a consumer operated kiosk system 1150 with a table-based kiosk 1100 configured in accordance with another embodiment of the disclosure, and FIG. 11B is a top view of the table-based kiosk 1100. The kiosk 1100 can include many features that are at least generally similar in structure and function to the features of the kiosks described above. In the illustrated embodiment, at least some of the kiosk components are installed in a table 1148 with one or more user interfaces 1102 positioned substantially flush with the top of the table 1148 and one or more corresponding dispensers 1104 (e.g., product sample dispensers, coupon or voucher dispensers, etc.). In other embodiments, some of the components of the kiosk 1100 can be positioned elsewhere in or relative to the table 1148. The user interfaces 1102, for example, can rest vertically atop the table 1148 (e.g., similar to a home computer) or project at an angle from the table 1148, and the dispensers 1104 can be positioned below the tabletop. The table-based kiosk 1100 allows consumers to sit while they shop for and test product samples. In certain aspects of the kiosk 1100, the dispensers 1104 can dispense vouchers or coupons to consumers that can be provided to a sales clerk or automated vending device to retrieve selected product samples. In other embodiments, the product samples can be dispensed at the table 1148 itself. As shown in FIG. 11A, the kiosk system 1150 can also include a large display panel 1130 with individual display compartments 1132 positioned in view of the kiosk 1100 to advertise product samples.

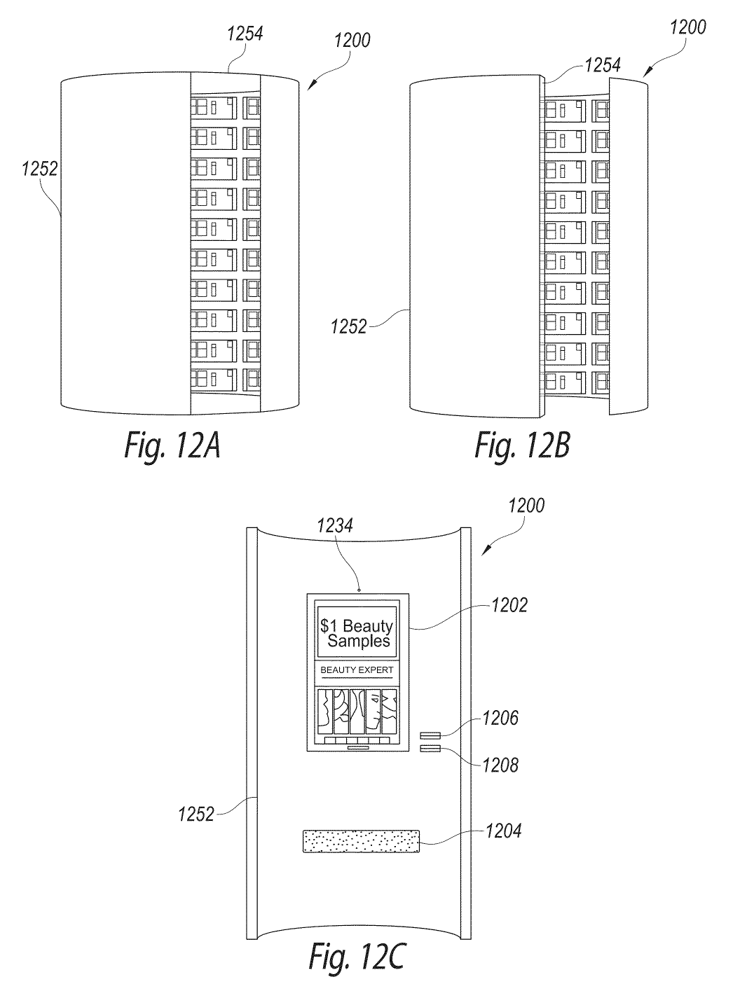

FIGS. 12A and 12B are isometric views of a consumer operated kiosk 1200 in closed and open positions, respectively, configured in accordance with yet another embodiment of the disclosure. FIG. 12C illustrates an interior area or portion of the kiosk 1200 of FIGS. 12A and 12B. The kiosk 1200 can include many features that are at least generally similar in structure and function to the features of the kiosks described above. The kiosk 1200, however, is configured as a booth in which consumers can view and purchase product samples in a substantially private enclosure. Referring to FIGS. 12A and 12B together, the booth kiosk 1200 includes a housing or shell 1252 that defines an enclosure configured to accommodate a consumer and a door 1254 (e.g., a sliding glass door) that can be manually or automatically opened (FIG. 12B) and closed (FIG. 12A) to provide access to the kiosk 1200. The interior of the shell 1252 can be used to display the product samples (e.g., using backlit display compartments, graphic displays, etc.) available for purchase at the kiosk 1200. As shown in FIG. 12C, additional components of the kiosk 1200, such as a user interface 1202 and a product dispenser 1204, are also positioned within the shell 1252. In various embodiments, the outside of the shell 1252 can include advertisements related to the kiosk 1200 and/or the products sold therein.

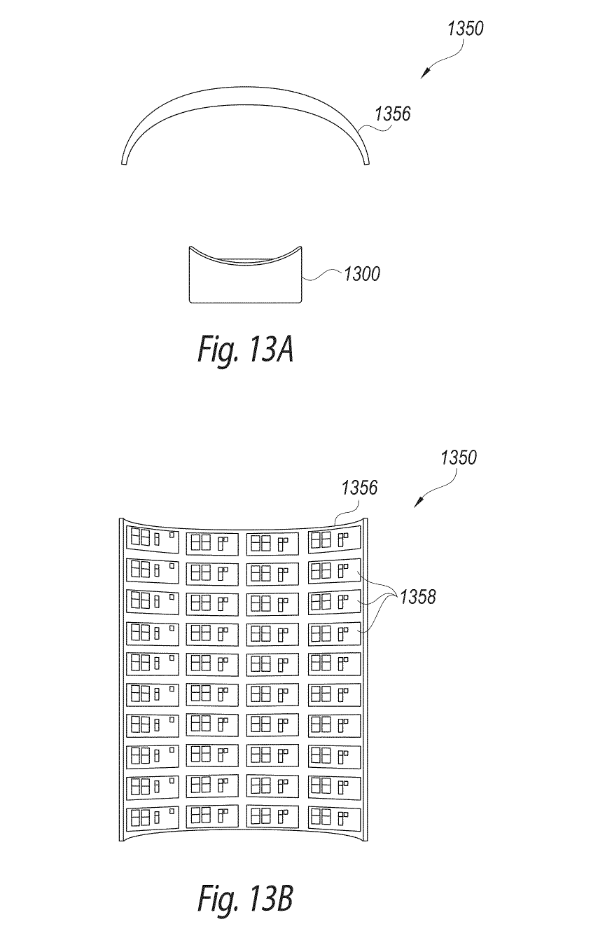

FIGS. 13A and 13B are top and front interior views, respectively, of a consumer operated kiosk system 1350 configured in accordance with yet another embodiment of the disclosure. The kiosk system 1350 can include a kiosk 1300 having many features that are at least generally similar in structure and function to the features of the kiosks described above. Similar to the kiosk 1200 of FIGS. 12A-12C, for example, the kiosk system 1350 shown in FIGS. 13A and 13B provides consumers with partial enclosure for viewing and testing product samples. As shown in FIG. 13A, for example, the kiosk system 1350 can include a privacy wall 1356 spaced a distance from the front of the kiosk 1300 to partially block the kiosk 1300 from public view. As shown in FIG. 13B, the privacy wall 1356 can display images 1358 related to the product samples available for purchase at the kiosk 1300. In various embodiments, the privacy wall 1356 can be configured as an interactive user interface that allows consumers to expand upon the display images 1358 to view additional product information.

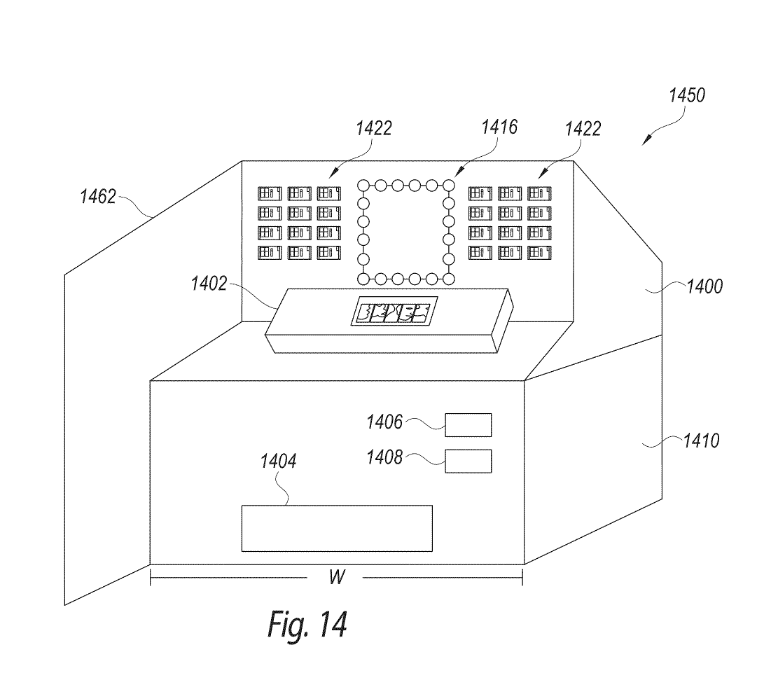

FIG. 14 is an isometric view of a consumer operated kiosk system 1450 configured in accordance with a further embodiment of the disclosure. The kiosk system 1450 can include a kiosk 1400 having features generally similar in structure and function to the features of the kiosks described above. The kiosk 1400, for example, includes a mirror 1416 positioned over a user interface 1402 to allow consumers to test the product samples purchased from the kiosk 1400. The kiosk 1400 also includes a plurality of light boxes 1422 surrounding the mirror 1416 that display graphics associated with the product samples for sale at the kiosk 1400. The kiosk system 1450 can further include a side panel 1462 attached to the kiosk 1400 for displaying information or advertisement panels and/or additional light boxes. In one embodiment, the kiosk 1400 can have a width W at its base of 3 ft. In other embodiments, the kiosk width W can be larger or smaller.

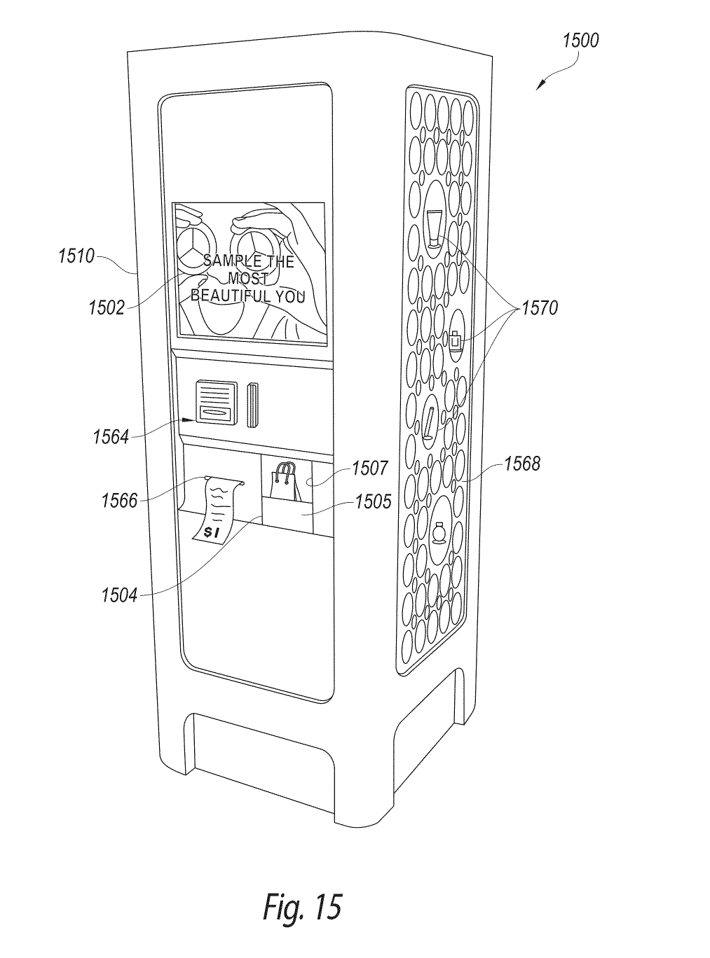

FIG. 15 is an isometric view of a consumer operated kiosk 1500 for sampling products configured in accordance with yet another embodiment of the disclosure. The kiosk 1500 can include features generally similar in structure and function to the features of the kiosks described above. The kiosk 1500, for example, includes a housing 1510, a user interface 1502 (e.g., a touch screen) to communicate with consumers, a payment area 1564 including one or more mechanisms for accepting payment from consumers (e.g., a card swipe, a currency acceptor, etc.), and a product dispenser 1504 that dispenses product samples (illustrated as a shopping bag). The product dispenser 1504 can include an automated door or panel 1505 that hides an opening 1507 of the product dispenser 1504 before a sample is dispensed. Upon selection of and payment for a product sample, the panel 1505 can slide away from or otherwise reveal the opening 1507 to display the sample to the consumer. The panel 1505, for example, can move downward in the direction of the arrow as the sample is being lowered on an elevator-style delivery mechanism (described in further detail with reference to FIGS. 16A-16D).

As shown in FIG. 15, the kiosk 1500 also includes a receipt or coupon dispenser 1566 that can be coupled to a printer (not shown) within the housing 1502. As discussed above, the kiosk 1500 can be configured to dispense coupons (e.g., $1 off coupons) to a consumer via the dispenser 1566 based on the samples the consumer selects.

In the illustrated embodiment, the housing 1502 includes a side panel or wall 1568 that includes a plurality of product displays 1570 for displaying commercially sold versions of the samples sold by the kiosk 1500. In other embodiments, the side walls 1568 of the kiosk 1500 can include other types of product displays or messaging for the consumer.

FIGS. 16A-16D illustrate various aspects of a robotic retrieval system 1672 within a housing 1610 of a consumer operated kiosk 1600 configured in accordance with an embodiment of the disclosure. The kiosk 1600 can include one or more carousels or rotating structures 1674 (identified individually as first and second rotating structures 1674a and 1674b, respectively) comprised of multiple rows of holders or receptacles that releasably retain individual product samples available for purchase at the kiosk 1600 (i.e., the kiosk inventory). As shown in FIGS. 16A and 16B, for example, the first carousel 1674a can include a plurality of holding slots or couplers (not shown) that releasably retain individual bags or envelopes 1676 in two rows 1678. In other embodiments, the first carousel 1674a can include one row 1678 or more than two rows 1678. As shown in FIGS. 16A and 16C, the second carousel 1674b can include multiple rows 1678 of shelves 1680 that retain individual product samples packaged in bags 1682, boxes, and/or other suitable containers for product samples. In other embodiments, the carousels 1674 may include different features for releasably securing various types of product samples within the housing 1610 of the kiosk 1600.

The robotic retrieval system 1672 can further include one or more robotic arms or picker robots 1684 (identified individually as a first picker robot 1684a and a second picker robot 1684b) that are configured to remove the product samples from the carousels 1674. The first picker robot 1684a, for example, can include pinch rollers for removing the envelopes 1676 from the first carousel 1674a, and the second picker robot 1684b can include a mechanical hook that slides or grasps the bags 1680 from the shelves 1682. In other embodiments, the robotic retrieval system 1672 can include picker robots 1684 having other suitable features for retrieving product samples from the carousels 1674.

The carousels 1674 can be operably coupled to a stepper motor (not shown) to precisely rotate a selected shelf 1680 or envelope holding slot into alignment with one or more of the picker robots 1684. In various embodiments, for example, the envelope holding slots and/or the shelves 1680 are attached to one or more shafts (not shown) that are in turn operably coupled to the stepper motor. The stepper motor can rotate the first carousel 1674a and/or the second carousel 1674b such that a product sample (positioned on a shelf 1682 or hook) is placed in a predefined or fixed position aligned (e.g., at least with respect to the x- and y-coordinates) with one of the picker robots 1684. In some embodiments, the stepper motor and the carousels 1674 are configured to rotate the individual rows 1678 or individual carousels 1674 independently of one another (e.g., on separate rotating members), and in other embodiments the rows 1678 and/or the carousels 1674 may be rotated in unison.

The picker robots 1684 can also be operably coupled to one or more stepper motors 1686 (e.g., a Z-position stepper motor) that allows precise vertical positioning of one of the product picker robots 1684 to align the picker robot 1684 with a selected row 1678 of the carousels 1674. As shown in FIG. 16A, for example, the first and second picker robots 1684a and 1684b can move along shafts 1692 extending along the length of the carousels 1674 (e.g., as indicated by the arrows). Once at the selected row 1678, the picker robot 1684 can slide, pinch, or otherwise remove the product sample from the carousel 1674, and move it onto a retrieval shelf or support 1688 (FIG. 16C). The retrieval shelf 1688 can then pivot and place the product sample on a vend elevator 1690 (FIG. 16D). The vend elevator 1690 lowers or raises the product sample to a vend area (e.g., an opening in the kiosk housing 1610) for consumer access. In other embodiments, the vend elevator is omitted, and the picker robots 1684 position the product samples onto a dedicated area for vending (e.g., a consumer accessible slot).

The robotic retrieval system 1672 and/or portions thereof can be incorporated into any one of the kiosks described above to store and deliver product samples from within a kiosk to a consumer (e.g., via a dispensing slot or designated vend area). In other embodiments, the kiosks can include other suitable types of retrieval systems configured to deliver selected product samples to the consumers.

From the foregoing, it will be appreciated that specific embodiments of the disclosure have been described herein for purposes of illustration, but that various modifications may be made without deviating from the spirit and scope of the invention. Aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

I/we claim:

1. A method of selling beauty products, the method comprising:
providing a consumer operated kiosk including an inventory of product samples, wherein the product samples correspond to products available for purchase by consumers at a point of sale in a retail establishment;
displaying product information on the kiosk, wherein the product information is related to the product samples in the inventory of the kiosk;
receiving a user selection corresponding to at least one of the product samples;
receiving payment for the selected product sample; and
dispensing the selected product sample to the user from the kiosk.

2. The method of claim 1, further comprising dispensing a coupon from the kiosk, wherein the coupon includes a discount on a price of a product related to the selected product sample available for purchase at the point of sale, and wherein the discount has a value related to a purchase price of the selected product sample.

3. The method of claim 2 wherein the value of the discount is equivalent to the purchase price of the selected product sample.

4. The method of claim 1, further comprising:
receiving user identification information from the user via the kiosk;
associating the user identification information with a discount, wherein the discount applies to a price of a product related to the selected product sample available for purchase at the point of sale, and wherein the discount has a value related to a purchase price of the selected product sample; and
transmitting the discount from the kiosk to the point of sale via a communications link.

5. The method of claim 1, further comprising:
receiving credit card information from the user via the kiosk for payment of the selected product sample;
associating the credit card information with a discount on a price of a product related to the selected product sample available for purchase at the point of sale;
transmitting the credit card information and the discount to the point of sale via a communications link; and
deducting the discount from the price of the product at the point of sale when the user provides the credit card information.

6. The method of claim 1 wherein displaying product information on the kiosk comprises displaying graphics associated with the product samples in a lighted display panel.

7. The method of claim 1, further comprising receiving user identification information via a user interface, wherein the user identification information associates the user with the selected product sample.

8. The method of claim 1, further comprising:
displaying search options on a user interface, wherein the search options are related to the product samples in the inventory of the kiosk, the search options including product categories comprising at least one of face, lips, eyes, skincare, hair products, and fragrance; and
receiving a selection from the user via the user interface, wherein the selection corresponds to at least one of the search options.

9. The method of claim 1, further comprising:
displaying a palette of shades associated with the selected product sample on a user interface;
receiving a selection from the user related to at least one of the shades via the user interface; and
wherein dispensing the selected product sample from the kiosk comprises dispensing the selected product sample in the selected shade.

10. The method of claim 1, further comprising:
taking a photo of the user;
determining coloring characteristics of the user from the photo; and
recommending beauty products related to the coloring characteristics.

11. The method of claim 1, further comprising:
receiving information related to coloring characteristics of the user; and
displaying beauty advice associated with at least one of the selected product sample and the coloring characteristics of the user.

12. The method of claim 1, further comprising:
releasably retaining individual product samples in predefined positions on a rotatable carousel;
rotating the carousel to rotationally align the predefined position of the selected product sample with a robotic arm;
moving the robotic arm to align with the predefined position of the selected product sample;
removing the selected product sample from the carousel with the robotic arm; and
moving the selected product sample to a product dispenser.

13. The method of claim 1, further comprising tracking the inventory of the product samples from a remote computer.

14. A method of selling beauty products, the method comprising:
positioning a consumer operated kiosk in a retail location, wherein the consumer operated kiosk comprises an inventory of beauty product samples and a user interface, and wherein the beauty product samples correspond to beauty products commercially available at the retail location;
displaying product information at the kiosk, wherein the product information is related to the beauty products samples in the inventory;
receiving a user selection corresponding to at least one of the beauty product samples via a user interface;
receiving user identification information via the user interface;
correlating the user identification information with a discount on a purchase price of a beauty product related to the selected product sample; and
providing the user with the selected beauty product sample.

15. The method of claim 14, further comprising transmitting the discount and the user identification information to a point of sale at the retail location.

16. The method of claim 14, further comprising transmitting a virtual coupon associated with the discount to the user.

17. The method of claim 14, further comprising:
associating the user identification information with the selected product sample; and
communicating information about the beauty product samples selected by the user at the kiosk to a remote computer communicatively coupled to the kiosk.

18. The method of claim 14, further comprising providing a coupon to the user via the kiosk, wherein the coupon has a value associated with a purchase price of the selected product sample.

19. A consumer operated kiosk for sampling beauty products, the kiosk comprising:
an inventory of a plurality of beauty product samples;
a user interface configured to receive a user selection related to at least one of the beauty product samples;
a display configured to display information associated with the plurality of beauty product samples; and
means for selectively dispensing beauty product samples in response to the user selection.

20. The consumer operated kiosk of claim 19, further comprising a communications facility configured to communicate information to a central computer, wherein the information is related to user selections, and wherein the information is available for access by remote kiosks.

21. The consumer operated kiosk of claim 19, further comprising a communications facility configured to communicate discounts to a point of sale, wherein the discounts are related to user selections and beauty products commercially available at the point of sale.

22. The consumer operated kiosk of claim 19, further comprising a communications facility configured to virtual coupons to users, wherein the coupons are related beauty products commercially available at a point of sale.

23. The consumer operated kiosk of claim 19 wherein the means for dispensing beauty product samples comprises:
a rotatable structure configured to releasably retain the beauty product samples in predefined positions; and
a robotic arm configured to selectively locate selected beauty product samples according to the predefined positions of the selected beauty product samples.
